(19) United States
(12) Patent Application Publication
(10) Pub. No.: US 2022/0100717 A1
(43) Pub. Date: Mar. 31, 2022

(54) Database and data deletion procedure

(71) Applicant: AKARION AG, Munich (DE)

(72) Inventors: Sascha MASCHEK, Linz (AT); Paul Emathinger, Linz (AT)

(73) Assignee: AKARION AG, Munich (DE)

(21) Appl. No.: 17/279,270

(22) PCT Filed: Sep. 24, 2019
(86) PCT No.: PCT/DE2019/100841

§ 371 Date: Mar. 24, 2021

(30) Foreign Application Priority Data
Sep. 24, 2018 (DE) 10 2018 123 463.5

(51) Int. Cl. G06F 16/215

(52) U.S. Cl. CPC G06F 16/215

(57) ABSTRACT

A method for deleting a data element from a data structure includes the steps of calculating a hash value based on at least the data element to be deleted within an instance, and replacing the data element in the data structure with the calculated hash value.

### TECHNICAL BACKGROUND

The invention discussed below relates to a computer-implemented method for processing data records comprising attributes or other data elements in a database, wherein an original data record and further original data records are linked by functional and/or logical references, wherein a hash value is optionally created by means of a hash function when the data records are created and/or when they are modified, the hash values describing the relevant attributes of a data record, the attributes comprising at least one time attribute, user attributes and references between the individual user attributes, the time attribute describing the time of creation or modification of an attribute or of the data record, the user attribute comprising an indication of the user carrying out the creation or modification of a data record and/or of a device to be operated by the user.

Especially when managing personal data, there is an interest in being able to trace all changes in a database at any time or at least within a defined period of time.

The present invention relates to the technical field of data processing. In this technical field of data processing, various techniques are known from the prior art.

In the prior art, a technique is known in which a so-called scatter value (hash value) is calculated from data. A so-called scatter value function (hash function) is regularly used. Such a hash function is provided in the state of the art, for example, by the secure hash algorithm (SHA). With a hash function, a data block that is not necessarily limited in size can often be mapped to a data block of fixed size, the hash or hash value. A typical length for a hash is 256 bits, for example. A desirable property of a good cryptological hash function is an approximate injectivity and an approximate collision resistance achieved thereby. The “ideal hash function” is therefore completely link-unique and collision-free and always maps different input data to different hashes.

In a typical use case for a hash function, a hash value is calculated for a larger amount of data. For example, a larger amount of data is to be transmitted via a transmission medium that may not be secure, such as the internet. For example, a technical error may cause part of the data to be transmitted incorrectly or a third party may manipulate this data.

If the sender of the data calculates its hash value and makes this hash value available to the receiver, the receiver can verify that the data is genuine and uncorrupted, provided that the hash value itself is genuine and reliable.

However, the procedure has the disadvantage that the procedure is completely overridden if the hash value itself is manipulated. In an example, a user A transmits a file to a user B and also the hash value of the file. An attacker C intercepts this communication and replaces the file with a forged file. The forged file contains forged data. In addition, C replaces the hash value of the file with the hash value of the forged file. If B now receives the data and checks it by calculating the hash function of the file itself and comparing it with the hash value, he concludes that the data has not been manipulated. Thus, C has successfully manipulated the data without B noticing.

To avoid this, another method is known as block chaining. A block chain consists of data that is organised in the form of data blocks that are strung together. If necessary, another data block can be added to a block chain at the end of the block chain. A hash value of the previous block, in addition to any user data, is stored in each new block.

If a block within the blockchain is manipulated by an attacker, the chain becomes inconsistent. For a successful manipulation, a certain part of the chain must therefore be recalculated by the attacker. The blockchain thus provides a high level of data integrity for the data stored on it.

Blockchaining has various areas of application. Block chaining can be used in the area of virtual currencies, for example in the currency Bitcoin. In Bitcoin, a blockchain consists of a series of data blocks in which one or more transactions are combined and provided with a checksum, i.e. they are combined in pairs to form a hash tree.

However, the state of the art for blockchaining has the disadvantage that it is poorly scalable. Since blockchaining is communication and computation intensive because all the “nodes” involved in blockchaining have to be reconciled with each other, the current state of the art is that only a very small number of transactions (i.e. entries into a blockchain) can be carried out per second worldwide. However, there is a growing demand for storage space and other resources such as bandwidth.

For transparency purposes, blockchains are often publicly accessible, which makes them verifiable, but also visible to others. This has the disadvantage that confidential data cannot be introduced into the chain or that third parties have to take note of the data.

Another disadvantage is the low flexibility of chaining. Often, data is only needed for a certain period of time and is then superfluous, should be anonymised or pseudonymised (or should even be deleted completely, e.g. to meet legal requirements, e.g. in data protection). However, if this data is now included in the blockchain, it is a fixed part of the chain, occupies resources and cannot be easily removed or changed without destroying the chain.

In addition, the redundant storage of data, which is necessary due to secrecy and the associated requirement of data immutability, is very cost-intensive, whereby enormous costs can arise even for the storage of small amounts of data.

The present invention is therefore based on the technical task of providing methods that overcome the disadvantages of the prior art and enable new solutions. In particular, more flexible, scalable, secure, data protection-compliant and reliable solutions are required. The cost minimisation factor also plays an essential role.

The disadvantages of the prior art are overcome by the method for securely deleting data of a data structure according to claim 1.

### DESCRIPTION OF THE INVENTION

The present invention provides a method for deleting a data element having the features of claim 1.

Further advantageous embodiments are given in the subclaims.

Accordingly, a method for deleting a data element from a data structure is provided, comprising the following steps: Calculating a hash value based on at least the data element to be deleted within an instance, and replacing the data element in the data structure with the calculated hash value.

Replacing deletes the data element itself in a data protection compliant manner. A data element can be verified by calculating its hash value and comparing this hash value with a reference value. If a data element has already been deleted from the data structure using a method according to claim 1, the data integrity can still be verified by reading out the hash. This is possible because the hash is still present and can be read out if the data element has been deleted with the method according to claim 1. This ensures that an instance can be verified even if one or more data elements have already been deleted. This also ensures that the verification of remaining data is also not affected by the deleted element.

In particular, the hash value, or another fingerprint based on this hash value, can be stored in a public medium and/or a medium that is difficult to change, such as a blockchain. Data integrity can then be verified with this very secure hash value. At the same time, confidentiality is maintained and the method according to claim 1 can delete the data element in a data protection compliant manner. Only the hash value remains in the medium that is difficult to change and/or public. The attacker cannot find there the source data constituting the deleted data element. The attacker cannot reconstruct deleted data elements because the hash on the public medium was aggregated from many individual hashes.

According to a further development, the calculation of hash values for data elements is performed on the basis of a structure comprising the data element and another data element, in particular a seed/salt.

A good hash function should not be reversible or only under difficult circumstances. However, so-called brute force attacks are possible. In one variant, an attacker uses a so-called dictionary attack.

In a simple example with only one data element, the data element is given by “John”. The associated SHA256 hash value is given by a8cfcd74832004951b4408cdb0a5dbcd8c7e52d43f7fe244bf720582e05241da. An attacker opts for a dictionary attack and checks known first names. By limiting himself to first names, his attack is very efficient. After a short time, he determines by trial and error based on the dictionary that the hash quoted above corresponds to the data element “John”. Thus, the attacker has obtained the original data based on a hash value. Such an attack is also conceivable for instances with several data elements.

The inclusion of another data element makes dictionary attacks much more difficult, especially if it has no systematic-content reference to the data elements.

The inclusion of another data element, in particular a seed/salt, in the procedure for securing ensures that it is extremely difficult or practically impossible for an attacker to reconstruct the data from the master hash value secured on the medium or system that algorithmically and/or mathematically secures the integrity of the data stored on it.

The inclusion of another data element, in particular a seed/salt, in the procedure for deleting a data element also ensures that it is extremely difficult or practically impossible for an attacker to reconstruct the deleted data element from the hash value with which the data element was replaced during deletion.

This makes it possible to better secure the confidentiality of the data and to work in a data protection-compliant manner.

According to a further development, the original data element in the data structure is at least partially overwritten by the calculated hash value and/or areas of the original data element that have not been overwritten by the calculated hash value are overwritten with other data, in particular randomised data, in particular multiple times.

In this way, the data element to be deleted is deleted in a particularly secure and data protection-compliant manner, and cannot be reconstructed by an attacker from the overwritten memory area.

Preferably, the entire original structure comprising the data element and another data element, preferably a seed/salt, is overwritten in the data structure by the originally calculated (single) hash value.

Alternatively, it can be provided that at least the data element of the original structure, which comprises the data element and a further data element, preferably a seed/salt, is overwritten within the data structure with other data, in particular randomised data, in particular several times. It is important here that the data used to overwrite the data element, together with the remaining further data element, preferably the seed/salt, map the hash value that was originally calculated on the basis of the structure comprising the data element to be overwritten and the further data element, in particular the seed/salt.

The present invention also includes a computer, computer network or computer system, in particular a distributed computer system, arranged to perform a method disclosed herein for deleting a data item.

In addition to the aforementioned computer, computer network or computer system, the present invention further comprises a computer program comprising instructions for causing the computer, computer network or computer system to perform the method steps of the method disclosed herein.

Finally, the present invention also includes a computer-readable medium on which the aforementioned computer program is stored.

Further technical advantages will be apparent to the skilled person from the following explanations of the invention:

The term data set is understood by the expert to mean a group of content-related attributes, i.e. data elements, which belong to a specific object and which have identical structures within a data set. Data sets correspond to a logical structure that was defined when a document was created (e.g. in the conceptual schema of data modelling).

As is clear herein, an attribute is thus a data element within a data set. For example, text data, i.e. character strings, are used as data introduced into such a data element, although the invention is not limited to text data as a data type, but may also include other data types such as image data, audio data, video data, binary data, etc. Files or parts of files can also be used as data. For example, the data may thus also be in a file format or a format or a form that resembles a file format. In another example, data in JavaScript Object Notation (JSON) format is used.

For example, the data may be designed to contain data elements that are in a file format. For example, an image can be a data element and be in JPEG format. However, data elements can also be smaller units. In particular, a file format can, for example, define the structure that is superordinate to the data elements. For example, a file may be in JSON format and contain many data elements, with the data elements themselves containing text data, for example.

The method according to the invention addresses the problem of the

Traceability of changes to records of a database. The technical solution outlined below provides for the creation of a generic database, whereby the database is particularly suitable for the management of personal data, but also for the management of arbitrarily designed object data. A data set can be a set of data of any design. Different data sets can be identical, different or overlapping, and are therefore also referred to as data instances or instances.

According to the invention, this is achieved by maintaining an original record unchanged in the event of a user-ordered modification of an entry of the record and creating a new record comprising the modified entry, wherein new references are created from the new record to the further original records and a modification reference is created from the new record to the original record, wherein the modification reference documents a temporal development and, if applicable, a functional reference and, if applicable, a logical reference and, if applicable, an instance reference is identified between the original record and the temporally subsequent record.

The method according to the invention solves the technical task of tracing changes mentioned at the beginning by not changing the original data record and creating a new data record comprising a new or changed attribute. All changes are traceable on the basis of the original data record and the new data record.

A logical reference exists when a record A1 on a first timeline refers to a second timeline B by means of a logical reference, whereby the latest version of the record on timeline B is always shown.

The effect of a logical reference can be illustrated by the following example. A1 is a personal data record, whereby the personal data record refers to a data record B1 by means of a logical reference “CV”, whereby the data record B1 contains, among other things, the field “Employer”. If there is a change of employer, a new data record B2 is created, whereby the field “Employer” is filled with the current value in data record B2. A1 can remain completely unchanged, since the logical reference “CV” always implicitly references the latest version of the CV, which in this case is record B2.

An instance reference exists when a data set A1 on timeline A points to a very specific version B(n) of another data set on timeline B by means of a logical reference. Even if newer versions B(n+1) of the dataset arise on timeline B, this reference always points continuously to one and the same dataset instance B(n).

An instance reference can be explained using the following example. A1 contains a personal record consisting of surname and year of birth, such as the values “Mustermann” and “1980” respectively. In addition, A1 contains an instance reference to B1. B1 contains the data schema of the associated data records, in this example the values

“Surname”: “string” and “Year of birth”: “number”. Later, the data schema is changed, resulting in B2 containing, for example, the values “SV number”: “number” and “date of birth”: “string”. Newly created data records A(1+n) should now reference B2, but the existing data record A1 should still reference B1, as its content would not make any sense in the context of B2.

A functional reference has a functional relationship between a first record and a second record. For example, a first data set or an object represented by the first data set, such as a car, may condition the second data set or an object represented by the second data set, such as a car key, so that the first data set and the second data set or the objects represented by the data sets perform a function together.

At the same time, the creation of a modification reference, the original data record is referenced by the new data record, which in turn has the effect that the amount of data to be stored due to the modified entry can be reduced to the new data record comprising the modified entry. This means that the entire amount of data does not have to be stored again.

The modification reference always shows the development over time from the modified record to the original record, which makes it possible to describe the history of the modifications.

The modification reference may also include, in addition to the history documentation, a functional reference and/or a logical reference and/or an instance reference from the modified record to the original record.

The term “amended entry” is to be understood in the context of the disclosure of the method according to the invention to a new entry which requires the creation of a new attribute, especially since a new entry represents a change compared to the originally non-existent entry.

The individual original records have references. A newly stored data record comprising the new entry also has these references. After a functional and/or logical relationship is documented by the references between the attributes, the creation of the new data record can be checked with regard to this functional and/or logical relationship in the course of carrying out the method according to the invention. The creation of the new attribute as part of the method according to the invention thus has integrity against manipulation from the outside.

The method according to the invention may also comprise a method step of deleting and/or overwriting the original data records which are older than a defined period of time and/or swapping them out into another database.

The method according to the invention also addresses the problem of deleting records or attributes of data in blockchain databases. According to the state of the art, it is not possible to delete data records or attributes in such a way that the data stored in the form of these data or attributes are deleted.

information can no longer be viewed.

The method according to the invention solves the above problem in such a way that the data values of the data records ordered to be deleted by the user and/or the attribute values of the attributes are replaced by their hash value, possibly created using an application-specific secret key, so that the readable information can no longer be reconstructed. Such an application-specific secret key is also known under the terms seed or salt. The procedure described below can also be carried out as a procedure independent of the procedure described above.

The way in which the hash value is created, in particular the secret key, is not visible to third parties.

According to the invention, this is achieved by overwriting the relevant attribute value with the hash value of the attribute to be deleted when a user orders a delete function of an attribute value.

The method according to the invention solves the problem of deletion by overwriting or—figuratively speaking—by “blackening”. The invention described below is based on the fact that the attributes to be deleted by overwriting can be found in a database and that all attributes can be overwritten.

By overwriting the entry to be deleted with the relevant hash value, the entry to be deleted is made unreadable. Since the actual execution of a delete command is not feasible, the solution shown here aims at overwriting the entry by means of a non-reversible representation of the original data (hash value). The solution shown here provides in particular that the entry to be deleted is overwritten with the hash value that was originally generated from the entry to be deleted. The entry to be deleted can no longer be created from the hash value.

The method according to the invention can be characterised in that

the attribute value is overwritten by the hash value comprising a value to indicate the override. Such a flag is commonly referred to as a flag.

The simple overwriting of an attribute value of a data set with only a hash value leads to the fact that when a hash value describing the data set is created, a hash value is again created from the attribute value overwriting hash value. This process is not necessary for a sufficient redaction—in the sense of the above-mentioned task—or for solving the deletion problem.

For this reason, the hash value overriding the attribute value may include a tag.

The procedure of overwriting an attribute value can also be performed independently of the procedure of creating new records and the references as well as modification references described above.

According to the state of the art, the existence of data records can be proven by creating hash values without having to disclose the content of the data records in advance. The solution shown in the method according to the invention provides that this creation of the hash values based on the information stored in data records or attributes is used to keep the information stored in the data records or attributes in evidence as data or attributes that are no longer readable for the subsequent proof of freedom from manipulation.

The method according to the invention can also be supplemented in that, if necessary, a first hash value describing the data record at a time t1 and a second hash value describing the data record at a time t2 are created the first hash value and the second hash value being stored in a further database, and at a time t1′, if necessary, a further first hash value describing the data record stored at the time t1 and at a time t2′ a further second hash value describing the data record stored at the time t2 are created, the time t1′ being after the time t1 and the time t2′ being after the time t2.

This method step is particularly suitable for determining whether the data records stored in a first database have been corrupted after the creation of the respective hash value. For this purpose, a “fingerprint” of the data record, represented in the form of a first hash value, is created in the first database and/or in a second database. The second database can also be a public database, e.g. a public blockchain, especially since the data record is only represented by the hash value and is thus no longer traceable to the readable form.

This first hash value is compared with a further first hash value created later, whereby the further hash value is created according to the same criteria as the first hash value. This comparison can be used to determine whether the data set has been modified between the creation of the first hash value and the creation of the further hash value.

The method may comprise comparing the second hash value and the further second hash value. The method may further comprise comparing the first hash value and the further first hash value.

The process step of comparing the hash values and the further hash values can also be carried out as an independent process.

It is noted that the process step of deleting an attribute of data described here and below can also be carried out independently of the process steps listed above and below.

Moreover, the skilled person recognises that this principle of the

Overwriting an entry of an attribute is also applicable for several entries of attributes in order to delete data.

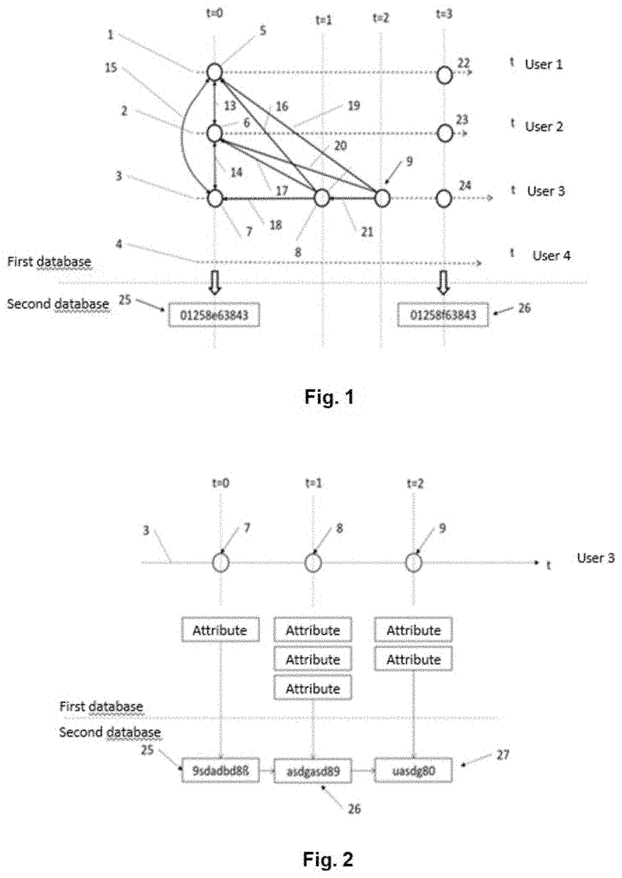

The partial processes according to the invention are illustrated in FIGS. 1 to 2 and explained in the description of the figures below. The person skilled in the art is able to carry out the processes illustrated in the figures according to the description below as separate processes or as one process combining the individually described processes. The skilled person is also able to combine the methods described in the figures with the features of the general description section.

FIG. 1 illustrates the systematics of the creation of the References and modification references of the method of processing personal data according to the invention and the advantages thereof.

FIG. 2 shows the possibilities of comparing the hash values and the other hash values.

In the figures, the following elements are identified by the preceding reference signs.

1 to 4 lines

5 to 12 records

13 to 15, 16, 17, 19, 20 References

19, 21 Modification references

22, 23, 24 Summary records

25 First hash value

26 Second hash value

27 Third hash value

FIG. 1 illustrates the system underlying the method according to the invention for the processing of personal data comprising attributes in a

Computer-implemented processes.

The data sets underlying this application example include user attributes, time attributes as attributes and, if applicable, value specifications.

The user attributes are created by an input via an input device or reader operated by a person.

The user attribute includes information about a person.

The time attribute describes the time of creation or change of the data or the respective attribute.

FIG. 1 comprises a number of horizontal dashed lines 1 to 4, whereby a line 1 to 4 stands for a user attribute. Furthermore, the lines 1 to 4 symbolise the time attribute in the form of a time axis beginning with a time t0. The lines 1 to 4 illustrate the temporal input behaviour of the users 1 to 4.

The personal data, which—as shown above—comprise several attributes, are represented in FIG. 1 by the individual data records. The individual data records are represented in FIG. 1 by the dots 5 to 12, whereby the personal data comprises the individual data records represented by the dots 5 to 12.

At time t0, the personal data comprise the data sets represented by items 5 to 6. The data sets 5 and 6 are functionally and/or logically related as indicated by references 13 to 15, the relationship not being a subject of the disclosure of the invention.

process. Such references are known in the prior art.

If an entry is made by the user 3 at a time t1, a new data record 8 is created under

Maintaining the associated original data set 7 generated.

The references between the data set 7 and the data set 5 or the data set 6 known in the prior art are also used in an analogous way for the data set 8.

created. The method according to the invention is thus characterised in that the references 16, 17 are created, the references 16, 17 indicating a functional and/or logical and/or instance relationship between the data set 8 and the data set 5 and the data set 6, respectively.

The method according to the invention is further characterised by the fact that a so-called modification reference 18 is created between the data record 8 created by the user 3 at time t=1 and the original data record 7 at time t=0. The modification reference 18 maps the historical development between the original data set 7 and the new data set 8. The change in the new data set 8 compared to the original data set 7 can thus be documented.

The method according to the invention may provide that only the modified attributes are stored in the new record 8, while the unmodified attributes are stored in the original record 7. The generation of the modification reference 18, wherein the modification reference indicates a historical relationship between the attributes of the original data set 7 and the new data set 8, enables an efficient design of the database.

The modification reference 18 represents, in a way that is clear to the controlling user, the modification of the original data set 7 or the attribute comprised by the original data set 7 to the new data set 8 or the attribute comprised by the new data set 8, respectively.

FIG. 1 shows the creation of another new data set 9 at a time t=2 by the user 3. The functional and/or logical references 19, 20 are again created between the further new data record 9 and the data record 6 and the data record 7 respectively. The creation of the references 19, 20 takes place in analogy to the references 13, 14

and/or to references 16, 17.

A further modification reference 21 is created, the further modification reference 21 identifying a historical relationship between the new record 9 and the original record 8, similar to the modification reference 18.

The method according to the invention may provide that data records which are older than the time t=2 or fall in the period beginning with t=0 to t=2 are deleted and/or swapped out to another database. In the context of the disclosure of the method according to the invention, the deletion of an attribute in the database and the swapping out, i.e. copying the attribute into another database and deleting the attribute in the database, are regarded as equivalent method steps with respect to the database, since in both cases the attribute is deleted in the database.

The generation of references between the new data sets 8, 9 and the original data sets 5, 6, 7 as described above allows the simple and quick creation of so-called summary data sets 22, 23, 24 at a point in time t=3, since the modification references 28, 21 in particular show the most recent changes. In FIG. 1, the summary data records 22, 23, 24 are shown on lines 1 to 3, as they summarise the result of the entries or changes made by the respective user.

FIG. 1 shows a further advantageous effect of the process according to the invention.

Independently, but also in addition to the system described above for the creation of the references 13-15, 16, 17, 19, 20 and the modification references 18, 21, a first hash value 25 describing the data sets 5, 6, 7 can be created at the time t=0 and before any modification of the data set 8 at the time t=1. The first hash value 25 may be stored in a second database physically independent of the first database, wherein the first database stores the data sets 5 to 9. Furthermore, a second hash value 26 describing the data sets 22, 23, 24 at the time t=3 and thus after the modification of the original data set 7 to the new data set 8 and the further new data set 9 can be created. The underlying data of the second hash value 26 thus differs from the first hash value 25 by the amount of the modifications made to the original data set 7.

At a later point in time t=3 another first hash value describing the data records at time t=0 (not shown in FIG. 1) and a further second hash value describing the data records at time t=3 (not shown in FIG. 1). A comparison of the hash values and a deviation of the second hash value 26 from the further second hash value is regarded as a clear indication of an unauthorised manipulation of the first database.

The creation of the references 13-15, 16, 17, 19, 20 and the modification references 18, 21 allow to trace any manipulation detected by the comparison of the hash values.

FIG. 2 illustrates once again, in comparison with FIG. 1 simplified diagram, the partial method of detecting a manipulation in the first database according to the invention.

FIG. 2 comprises a time axis 3, whereby the data sets 7, 8, 9 that are present or have been changed at the time are plotted on the time axis 3. The data sets 7, 8, 9 comprise a different number of attributes.

At the time t=0, a first hash value 25 is created describing the data set 7 at the time t=0 and thus before a change of the data set. The data set 7 comprises an attribute. The data set 7 is stored in a first database. The first hash value 25 is preferably stored in a second database physically separate from the first database at time t=0.

A data set 8 is created at time t=1. The Creation of record 8 occurs after the user 3 adds two more attributes to the attribute of record 7. As described above, the new data record 8 is created in order to be able to maintain the original data record 7 unchanged. A second hash value 26 describing the new data set 8 at time t=1 is created at time t=1. The new record 8 is stored in the first database, while the second hash value 26 is stored in a second database.

In analogy to the above, another new data record 9 is created at time t=2 under the removal of an attribute and thus after the removal of an attribute. A third hash value 27 describing the further new data record 9 at time t=2 is created, whereby the third hash value 27 is again stored in the second database.

At any time after t=0, a further first hash value 25 can be created, whereby the further first hash value 25 describes the data set 7. Likewise, at a time after t=1 and at a time after t=2, a further second hash value or a further third hash value can be created, whereby the further hash values describe the data sets 7, 8 at the time of the creation of the further hash values.

By comparing the further hash values with the hash values 7, 8, 9, a manipulation of the data records after the time of their creation can be determined.

### Other Aspects and Further Training

1. a computer-implemented method for processing personal data records comprising attributes in a database, wherein an original record and further original records are connected by functional and/or logical references, wherein, if applicable, a hash value is created by means of a hash function during the creation and/or during a modification of the data records, wherein the hash value describes the relevant attributes of a data record, wherein the attributes comprise at least a time attribute, user attributes and references between the individual user attributes, wherein the time attribute describes the time of the creation or the modification of an attribute or of the data set, wherein the user attribute comprises an indication of the user performing the creation or the modification of a data set and/or of a device to be operated by the user, characterised in that in the case of a user-ordered modification of an entry of the record by a user, an original record is maintained unchanged and a new record comprising the modified entry is created, new references being created from the new record to the further original records and a modification reference being created from the new record to the original record, the modification reference documenting at least a development over time and, if appropriate, a functional reference and, if applicable, a logical reference and, if applicable, an instance reference between the original data set and the temporally subsequent data set.

2. Method according to aspect 1, characterised in that the original data records which are older than a defined period of time are deleted and/or overwritten and/or stored in another database.

3. Method according to any one of aspects 1 to 2, characterized in that in the case of a delete function of an attribute value ordered by a user, the attribute value in question is deleted by the user using, if applicable, a The hash value of the attribute to be deleted is overwritten by the hash value created with the application-specific secret key.

4. The method of aspect 3, characterised in that the attribute value is overwritten by the hash value comprising a value identifying the override.

5. Method according to one of aspects 1 to 4, characterized in that, if appropriate, a first hash value describing the data record at a time t1 and a second hash value describing the data record at a time t2 are created, the first hash value and the second hash value being stored in a further database, and at a time t1′, if necessary, a further first hash value describing the data record stored at the time t1 and at a time t2′ a further second hash value describing the data record stored at the time t2 are created, the time t1′ being after the time t1 and the time t2′ being after the time t2.

6. A method according to aspect 5, characterized in that the second hash value and the further second hash value are compared.

7. A method according to any one of aspects 5 to 6, characterized in that the first hash value and the further first hash value are compared.

The above embodiments and further embodiments can be combined with each other as desired, if useful. Further possible embodiments, further developments and implementations of the invention also include combinations of features of the invention described above or below with respect to the embodiments that are not explicitly mentioned. In particular, the skilled person will also add individual aspects as improvements or additions to the respective basic form of the present invention.

1: A method of deleting a data element from a data structure, the method comprising:
a) calculating a hash value based on at least the data element to be deleted within an instance, and
b) replacing the data element in the data structure with the calculated hash value.

2: The method according to claim 1, wherein the calculating of the hash value takes place on the basis of the data structure comprising the data element and a further element.

3: The method according to claim 1, wherein the data element in the data structure is at least partially overwritten by the calculated hash value and/or wherein areas of the data element which have not been overwritten by the calculated hash value are overwritten with other data.

4: A computer, computer network or computer system, which is arranged to perform the method of deleting a data element according to claim 1.

5: (canceled)

6: A computer-readable medium, comprising instructions for causing a computer, computer network, or computer system to perform the method of deleting a data element according to claim 1.

7: The method according to claim 2, wherein the further element comprises a seed/salt.

8: The method according to claim 3, wherein the other data comprises randomized data.

9: The method according to claim 3, wherein the areas of the original data element which have not been overwritten by the calculated hash value are overwritten several times with other data.

10: The computer, computer network, or computer system according to claim 4, wherein the computer system comprises a distributed computer system.
